(19) United States
(12) Patent Application Publication
(10) Pub. No.: US 2019/0376546 A1
(43) Pub. Date: Dec. 12, 2019

(54) LIMITED CLEARANCE FASTENER DEVICE, AND AN AIRCRAFT WHEEL FITTED WITH SUCH A DEVICE

(71) Applicant: SAFRAN LANDING SYSTEMS, Velizy Villacoublay (FR)

(72) Inventor: Pierre PIZANA, Moissy-Cramayel (FR)

(73) Assignee: SAFRAN LANDING SYSTEMS, Velizy Villacoublay (FR)

(21) Appl. No.: 16/431,937

(22) Filed: Jun. 5, 2019

(30) Foreign Application Priority Data
Jun. 6, 2018 (FR) 1854915

(51) Int. Cl. F16B 13/06; F16B 3/06; F16B 19/02; B64C 25/36

(52) U.S. Cl. CPC F16B 13/066; B64C 25/36; F16B 19/02; F16B 3/06

(57) ABSTRACT

The invention provides a fastener device comprising a bolt for passing through two adjacent elements. The device comprises an expandable bushing in which the bolt extends, and at least one expander part partially engaged in the expandable bushing in order to cause said bushing to expand radially while tightening the bolt.

The present invention relates to a fastener device for passing through two adjacent elements. The invention also provides an aircraft wheel having a rim to which a sprocket is fastened by such fastener devices.

### TECHNOLOGICAL BACKGROUND OF THE INVENTION

In the field of aviation, aircraft are now being fitted with members for driving wheels in rotation in order to enable an aircraft to move on the ground without using its main engines. In general, these drive members comprise an electric gear motor having its outlet fitted with a pinion that co-operates with a sprocket, itself secured to an aircraft wheel. In that way, the gear motor drives rotation of the pinion, which in turn drives the sprocket and thus the wheel in order to move the aircraft.

In order to be fastened to the wheel, the sprocket generally has fastener tabs that are distributed symmetrically around the longitudinal axis of said sprocket. The fastener tabs co-operate with other fastener tabs present all around the inner perimeter of the rim of the wheel to form contact surfaces between the sprocket and said rim. A bolt passes radially between each pair of fastener tabs in order to hold the sprocket in contact with the rim and thus transmit the torque delivered by the gear motor. Specifically, contact between the sprocket and the rim is held by the bolts being tightened strongly.

Nevertheless, for obvious assembly concerns, such a fastener system necessarily imposes relatively large tolerances on the dimensions of the holes through which the bolts pass. Those tolerances can then lead to relative movement between the sprocket and the rim, thereby leading to “fretting”, i.e. contact wear.

### OBJECT OF THE INVENTION

An object of the invention is thus to propose a fastener device that obviates the above-mentioned drawbacks, at least in part.

### SUMMARY OF THE INVENTION

To this end, the invention provides a fastener device comprising a bolt for passing through two adjacent elements. The device comprises an expandable bushing in which the bolt extends, together with at least one expander part partially engaged in the expandable bushing in order to cause said bushing to expand radially while tightening the bolt.

Radial expansion of the bushing serves both to take up assembly clearance and also to become embedded in at least one of the adjacent elements so as to limit relative movement within the resulting assembly. Contact wear between the adjacent elements is thus limited, and potentially almost non-existent.

According to a particular characteristic, the radial expansion of the expandable bushing is elastic deformation of said bushing.

The deformation to which the expandable bushing is subjected while the bolt is being tightened is then reversible. The bushing thus returns to its initial shape after the bolt has been loosened, thereby enabling the assembly to be reversible and the bushing to be used more than once.

In particular manner, the expandable bushing is split longitudinally. This facilitates radial expansion of the bushing.

According to a particular characteristic of the invention, the expander part is of substantially frustoconical outside shape.

In particular manner, the expandable bushing has at least one end segment that is of substantially frustoconical inside shape.

According to a particular characteristic of the invention, the expandable bushing has two end segments, each having a frustoconical inside surface.

In a particular embodiment of the invention, the expandable bushing is arranged to extend in only one of the two adjacent elements.

In another embodiment of the invention, and in particular manner, the expandable bushing is arranged to extend at least in part in both adjacent elements.

According to a particular characteristic, the fastener device comprises two identical expander parts.

In particular manner, the bolt has a screw provided with a head having a frustoconical base for engaging in a frustoconical segment of the hole in one of the elements.

According to a particular characteristic, the head has a shoulder projecting beyond the base that is arranged in such a manner that the shoulder does not come into contact with the element when the base is co-operating with the frustoconical segment of the hole in the element.

Advantageously, the fastener device includes means for preventing the bolt from loosening.

In particular manner, the means for preventing the bolt from loosening comprise an anti-loosening cup and a split pin.

The invention also provides an aircraft wheel having a rim to which a sprocket is fastened by such fastener devices. The fastener devices are arranged so as to extend radially through a portion of the rim and a portion of the sprocket that face each other.

According to a particular characteristic of the invention, the rim and the sprocket have fastener tabs symmetrically distributed around the longitudinal axis of the rim and of the sprocket. The fastener tabs extend substantially axially and form portions of the rim and portions of the sprocket through which the fastener devices pass.

In particular manner, the bolt has a screw provided with a non-circular head that is shaped to be able to oppose turning of the screw.

Advantageously, the fastener tabs of the rim include respective axial grooves forming abutments against turning of the head of a screw.

The invention also provides landing gear including a leg having such a wheel at one end and a gear motor having an outlet shaft provided with a pinion arranged to mesh with the sprocket.

### DESCRIPTION OF THE FIGURES

The invention can be better understood in the light of the following description, which is purely illustrative and non-limiting, and which should be read with reference to the accompanying figures, in which:

FIG. 1 is a perspective view of a sprocket fastened to a rim of an aircraft wheel by means of a fastener device in a particular embodiment of the invention;

FIG. 2 is an exploded view of the fastener device shown in FIG. 1;

FIG. 3 is a view of the fastener device shown in FIG. 1, in section on a plane containing the axis of rotation of the aircraft wheel and the longitudinal axis of the device;

FIG. 4 is an exploded view of a fastener device in another embodiment of the invention; and

FIG. 5 is a view analogous to the view of FIG. 3, showing the fastener device shown in FIG. 4 when in operation.

### DETAILED DESCRIPTION OF A PARTICULAR EMBODIMENT OF THE INVENTION

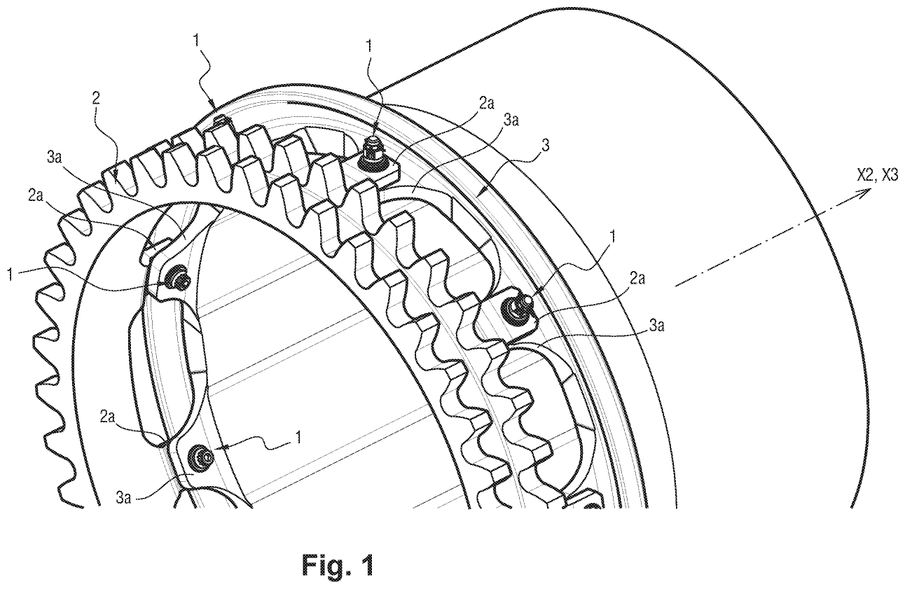

With reference to FIG. 1, fastener devices 1 in a particular embodiment of the invention are used for fastening a sprocket 2 to an aircraft wheel rim 3. The aircraft wheel is for mounting at the end of a leg of an undercarriage that is also fitted with a gear motor having an outlet shaft provided with a pinion that is arranged to mesh with the sprocket. The sprocket 2 is on the same axis as the rim 3, i.e. the longitudinal axis X2 of the sprocket 2 coincides with the axis of rotation X3 of the rim 3. In this example, the rim 3 is shown without its tire in order to clarify FIG. 1.

The sprocket 2 comprises two rows of teeth for co-operating with obstacles of a pinion driven by an electric motor. A first series of fastener tabs 2a are made integrally with the two rows of teeth and extend generally parallel to the longitudinal axis X2 of the sprocket 2. The fastener tabs 2a are substantially identical to one another, they are symmetrically distributed around the axis X2, and they extend beside the same one of the rows of teeth.

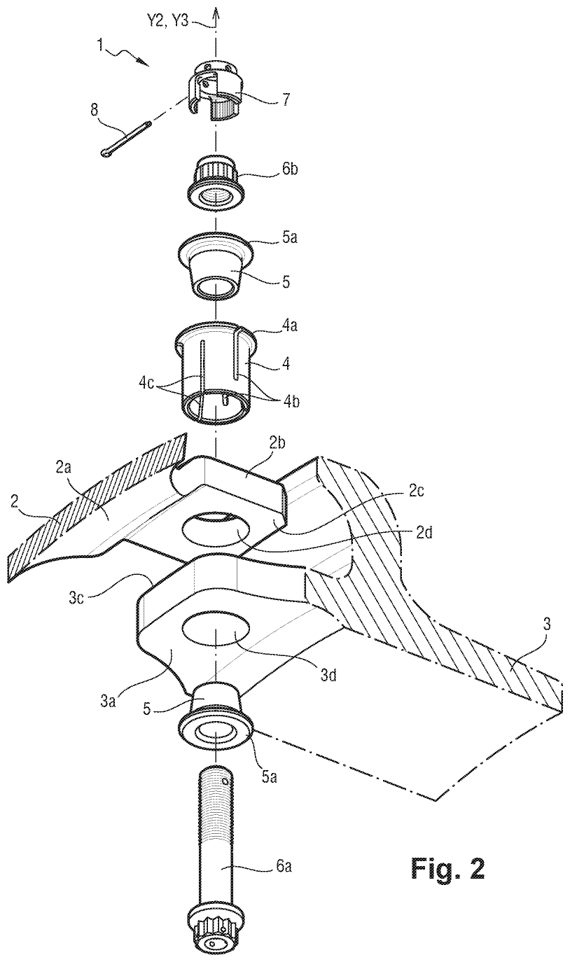

As shown in FIG. 2, each fastener tab 2a comprises, at a free end, a substantially plane portion 2b extending along the longitudinal axis X2 of the sprocket 2. Each portion 2b has an inside surface extending facing the axis X2 in order to form a contact surface 2c for contacting the rim 3. Each portion 2b has a hole 2d of circularly cylindrical shape about an axis Y2 that is substantially orthogonal to the axis X2 and to the contact surface 2c. The axes Y2 of the holes 2d in the fastener tabs 2a all lie in a common plane perpendicular to the longitudinal axis X2 of the sprocket 2.

Facing the first series of fastener tabs 2a of the sprocket 2, the rim 3 has a second series of tabs 3a that are of trapezoidal shape and that are made integrally with the body of the rim 3. Each fastener tab 3a extends facing the contact surface 2c of one of the fastener tabs 2a. The fastener tabs 3a are substantially identical and they extend parallel to the axis of rotation X3 of the rim 3 and they have outside surfaces facing away from the axis X3 in order to form contact surfaces 3c facing the contact surfaces 2c of the corresponding fastener tabs 2a of the sprocket 2. Each fastener tab 3a has a hole 3d of circularly cylindrical shape about an axis X3 that is substantially orthogonal to the axis X3 and to the contact surface 3c. The axes Y3 of the holes 2d in the fastener tabs 2a all lie in a common plane perpendicular to the longitudinal axis X3 of the rim 3.

The holes 2d and the holes 3d lie on substantially the same axes, i.e. the axis Y3 of the hole 3d of each fastener tab 3a coincides substantially with the axis Y2 of the hole 2d in the corresponding fastener tab 2a. Furthermore, in this example, the diameter of the hole 3d is substantially equal to the diameter of the hole 2d.

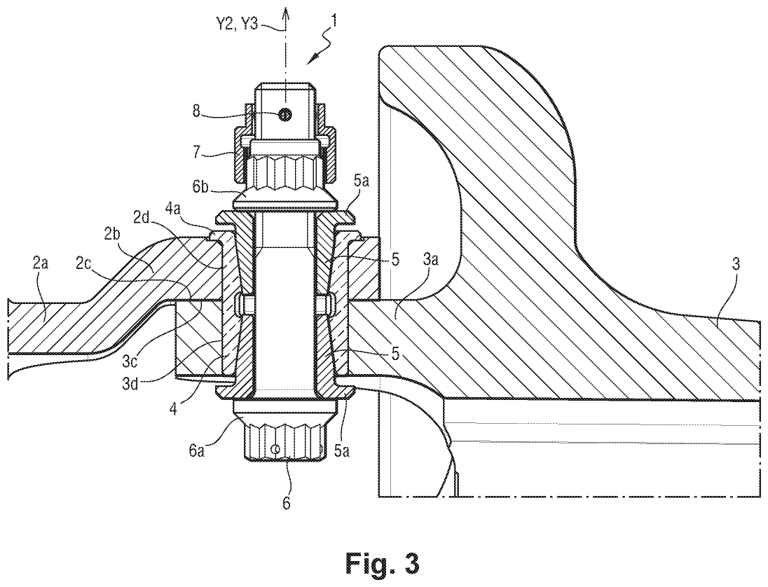

As shown in FIGS. 2 and 3, the fastener device 1 comprises an expandable bushing 4 of outside diameter perceptibly less than the diameter of the holes 2d and 3d. The bushing 4 extends through the holes 2d and 3d, and the longitudinal axis of the bushing 4 coincides substantially with the axes Y2 and Y3 of the holes 2d and 3d. A top end of the bushing 4 has a collar 4a forming an abutment against insertion of said bushing 4 into the fastener tab 2a. The collar 4a bears against the perimeter of the hole 2d in the fastener tab 2a. The bushing 4 presents a length defined between the collar 4a and a bottom end of the bushing 4 that is perceptibly shorter than the total thickness of the fastener tab 3a and the portion 2b of the fastener tab 2a.

The bushing 4 has an inside surface that is hourglass-shaped, being formed by two substantially identical opposing cone portions that are spaced apart by a radial groove arranged substantially at the center of said bushing 4. Furthermore, the bushing 4 has axial slots 4b opening out into the top end of the bushing 4 alternating with axial slots 4c opening out into the bottom end of the bushing 4. The slots 4b and 4c define elastically deformable blades that are formed in the bushing 4.

The fastener device 1 also has two expander parts 5 that are substantially cylindrical in shape on the inside and generally frustoconical in shape on the outside. The expander parts 5 can thus be thought of as conical rings each having a respective collar 5a at its larger end.

The two expander parts 5 are engaged in part in the bushing 4, one from the top end of said bushing, and the other from its bottom end. Each of the frustoconical portions of the two expander parts 5 co-operate with a respective one of the two frustoconical portions of the bushing 4. The collars 5a are not in contact with the top and bottom ends of the bushing 4, and the two expander parts 5 are not in contact with each other. The longitudinal axes of the expander parts 5 thus coincide substantially with the axes Y2 and Y3 of the holes 2d and 3d.

A bolt 6 passes through the two expander parts 5 that are engaged in the expandable bushing 4. The bolt 6 has a screw 6a comprising a partially threaded rod extending along the longitudinal axis of the expander part 5, i.e. substantially along the axes Y2 and Y3 of the holes 2d and 3d. At a non-threaded end of the rod, the screw 6a has a head with star-shaped engagement means and having its face bearing against the collar 5a of the expander part 5 engaged in the bottom end of the bushing 4.

The bolt 6 has a nut 6b screwed onto the threaded end of the rod of the screw 6a. The nut 6b has star-shaped engagement means identical to that of the head of the screw 6a, with the base of the nut 6b bearing against the collar 5a of the expander part 5 engaged in the top end of the bushing 4.

There follows a description of the operation of the fastener device 1. While tightening the bolt 6, the head of the screw 6a and the base of the nut 6b exert axial pressure on the expander part 5 along the axes Y2 and Y3 tending to move said expander parts 5 towards each other. Because of their frustoconical shape, the expander parts 5 moving towards each other exert stress on the frustoconical portions of the bushing 4, tending to deform said bushing radially. This radial deformation is facilitated by the presence of the slots 4b and 4c, with the elastically deformable blades then exerting radial pressure simultaneously on the wall of the hole 2d in the fastener tab 2a and on the wall of the hole 3d of the fastener tab 3a.

When the collars 5a of the expander parts 5 come respectively into contact with the bottom and top ends of the bushing 4, the radial deformation of the bushing 4 is such as to reduce or eliminate assembly clearances between the fastener tab 2a and the fastener tab 3a. The bushing 4 as expanded in this way prevents any relative movement between said sprocket 2 and said rim 3. The bushing 4 then acts as a peg in shear for transmitting torque from the sprocket 2 to the rim 3 of the aircraft wheel, which torque comes from the electric gear motor.

In order to prevent any untimely loosening of the bolt 6, the nut 6b may receive in conventional manner an anti-loosening cup 7 fitted over said nut. For this purpose, the anti-loosening cup 7 has a socket complementary to the star-shaped engagement means of said nut. A split pin 8 passes through the anti-loosening cup 7 and the threaded rod of the screw 6a, thereby preventing any relative turning between the screw 6a and the nut 6b.

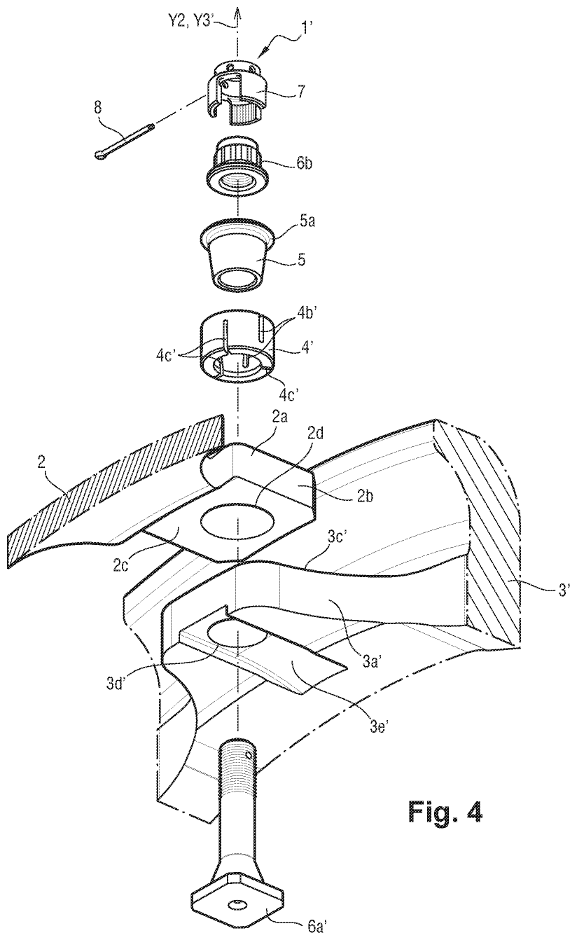

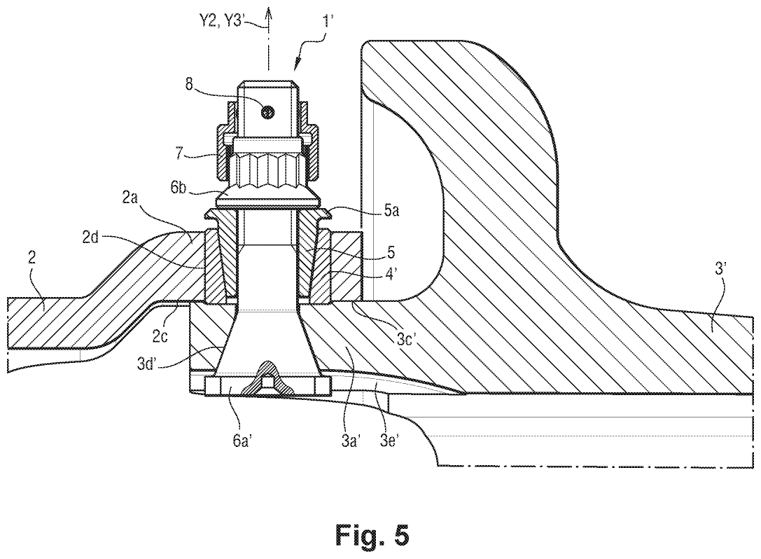

FIGS. 4 and 5 show a fastener device 1′ in a second embodiment of the invention.

Although the sprocket 2 is completely identical with the above-described sprocket, the rim 3′ differs from the rim 3 in that it has fastener tabs 3a′, each having a hole 3d′ of shape that is frustoconical (i.e. not cylindrical) about the axis Y3′ orthogonal to the axis of rotation of the rim 3′. In addition, the holes 3d′ are arranged in a plane bottom of an axial groove 3e′ formed in the bottom surface of each fastener tab 3a′. As in the first embodiment, a top surface of each fastener tab 3a′ forms a contact surface 3c′ for contacting a fastener tab 2a of the sprocket 2. The axis Y3′ coincides substantially with the axis Y2 of the hole 2d in the fastener tab 2a.

In this example, the fastener device 1′ has an expandable bushing 4′ of length substantially equal to the thickness of the portion 2b of the fastener tab 2a. The diameter of the bushing 4′ is perceptibly less than the diameter of the hole 2d in the fastener tab 2. The bushing 4′ is frustoconical in shape on the inside and has axial slots 4b′ opening out into a top end of the bushing 4′ and alternating with axial slots 4c′ opening out into a bottom end of the bushing 4′. In similar manner to the slots 4b and 4c, the slots 4b′ and 4c′ define elastically deformable blades in the bushing 4′.

In this example, the bushing 4′ is inserted into the hole 2d of the fastener tab 2a, with the bottom end of the bushing 4′ coming into contact with the contact surface 3c′ of the fastener tab 3a′.

An expander part 5 similar to that described above is engaged in part in the bushing 4′ from the top end of said bushing. The frustoconical portion of the expander part 5 co-operates with the frustoconical portion of the bushing 4′, and the collar 5a of the expander part 5 is not in contact with the top end of the bushing 4′. The longitudinal axis of the expander part 5 thus coincides substantially with the axis Y2 of the hole 2d.

A bolt 6′ passes through each fastener tab 3a′ and the expander part 5 engaged in the bushing 4′. The bolt 6′ comprises a screw 6a′ having a partially threaded rod that extends along the axis Y2, Y3′. At a non-threaded end of the rod, the screw 6a′ has a head with a frustoconical base co-operating with the frustoconical segment of the hole 3d′ in the fastener tab 3a′. The head of the screw 6a′ has a square shoulder projecting beyond the base and arranged in such a manner that said shoulder comes substantially into contact with the side walls of the axial groove 3e′, but not in contact with the plane bottom of the axial groove 3e′. The frustoconical base of the head of the screw 6a′ thus centers the screw 6a′ in the fastener tab 3a′ of the rim 3′ and eliminates radial assembly clearance between the screw 6a′ and the rim 3′.

The bolt 6′ has a nut 6b identical to that described above, which nut in this example is screwed onto the threaded end of the screw 6a′. A base of the nut 6b bears against the top end of the expander part 5 that is engaged in the bushing 4′.

The operation of the fastener device 1′ is similar to that described in detail above. While tightening the bolt 6′, the nut 6b exerts axial pressure on the expander part 5 along the axis Y2, Y3′. Because of its frustoconical shape, the expander part 5 then exerts stress on the conical portion of the bushing 4′ tending to cause said bushing to deform radially. This radial deformation is facilitated by the existence of the slots 4b′ and 4c′, with the elastically deformable blades then exerting radial pressure on the wall of the hole 2d in the fastener tab 2a.

When the collar 5a of the expander part 5 comes into contact with the top end of the bushing 4′, the radial expansion of the bushing 4′ is such that it reduces or even eliminates the radial assembly clearance between the screw 6a′ and the sprocket 2, thereby preventing any relative movement between said sprocket 2 and the rim 3′.

As above, the nut 6b can receive an anti-loosening cup 7 covering said nut together with a split pin 8 passing through the anti-loosening cup 7 and the threaded rod of the screw 6a′ in order to prevent any untimely loosening of the bolt 6′.

Naturally, the invention is not limited to the embodiments described, but covers any variant coming within the ambit of the invention as defined by the claims.

The term “hole” is used herein to mean a hole of any kind regardless of how it is made (boring, grinding, electroerosion, ultrasound, laser, . . . ).

The expandable bushings 4, 4′ need not include slots.

Although in this example the bushings 4 and 4′ have axial slots 4b, 4c, 4b′, 4c′, the bushings could also have radial slots or a single axial slot extending over the entire length of the bushing.

Although the bolt 6, 6′ is described herein as being tightened until the collar 5a of the expander part 5 comes into contact with the end of bushing 4, other procedures for tightening bolt 6, 6′ are possible. In particular, it is possible to envisage tightening the bolt 6, 6′ until reaching a predetermined torque, and without making contact between the collar 5a of the expander part 5 and the end of the bushing 4. Another possibility would be to tighten the bolt 6, 6′ until obtaining a predetermined distance between the collar 5a of the expander part 5 and the end of the bushing 4. By way of example, this distance may be monitored by means of a gauge block or shim. In any event, the expander part 5 needs to be shaped, in particular lengthwise, so that the tightening of the bolt 6 is sufficient to prevent any relative movement between the sprocket 2 and the rim 3.

Although the shape of the head of the screw 6a is described as being identical to the shape of the nut 6b (mainly for reasons of uniformity of tooling), it could be of some other shape, and in particular of hexagonal shape.

The groove 3e′ need not exist if the head of the screw 6a′ includes, as a replacement for its square shoulder, engagement means enabling turning of the screw 6a to be prevented. By way of example, the engagement means could be of hexagonal or star-shaped, i.e. of a shape similar to that of the screw 6a.

1. A fastener device (1, 1′) comprising a bolt (6, 6′) for passing through two adjacent elements (2, 3, 3′), the device (1, 1′) being characterized in that it comprises an expandable bushing (4, 4′) in which the bolt (6, 6′) extends, and at least one expander part (5) that is partially engaged in the expandable bushing (4, 4′) and that has the bolt passing therethrough with a portion bearing axially against the expander part in order to cause said bushing to expand radially while tightening the bolt.

2. A fastener device according to claim 1, wherein the radial expansion of the expandable bushing (4, 4′) is elastic deformation of said bushing.

3. A fastener device according to claim 1, wherein the expandable bushing (4, 4′) is split longitudinally.

4. A fastener device according to claim 1, wherein the expander part (5) is of substantially frustoconical outside shape.

5. A fastener device according to claim 1, wherein the expandable bushing (4, 4′) has at least one end segment that is of substantially frustoconical inside shape.

6. A fastener device according to claim 1, wherein the expandable bushing (4, 4′) has two end segments, each having a frustoconical inside surface.

7. A fastener device according to claim 1, wherein the expandable bushing (4, 4′) is arranged to extend in only one of the two adjacent elements.

8. A fastener device according to claim 1, wherein the expandable bushing (4, 4′) is arranged to extend at least in part in both adjacent elements.

9. A fastener device according to claim 1, including two identical expander parts (5).

10. A fastener device according to claim 1, wherein the bolt (6, 6′) has a screw (6a, 6a′) provided with a head having a frustoconical base for engaging in a frustoconical segment of the hole in one of the elements (3′).

11. A fastener device according to claim 10, wherein the head has a shoulder projecting beyond the base that is arranged in such a manner that the shoulder does not come into contact with the element (3′) when the base is co-operating with the frustoconical segment of the hole in the element (3′).

12. A fastener device according to claim 1, including means (7, 8) for preventing the bolt (6, 6′) from loosening.

13. A fastener device according to claim 12, wherein the means for preventing the bolt from loosening comprise an anti-loosening cup (7) and a split pin (8).

14. An aircraft wheel comprising a rim (3, 3′) having a sprocket (2) fastened thereto by fastener devices (1, 1′) according to claim 1, said fastener devices being arranged so as to extend radially through a portion of the rim (3, 3′) and a portion of the sprocket (2) that face each other.

15. An aircraft wheel according to claim 14, wherein the rim (3, 3′) and the sprocket (2) have fastener tabs (2a, 3a) symmetrically distributed around the longitudinal axis of the rim and of the sprocket, the fastener tabs (2a, 3a) extending substantially axially and forming portions of the rim and portions of the sprocket through which the fastener devices (1, 1′) pass.

16. An aircraft wheel according to claim 14, wherein the bolt has a screw provided with a non-circular head that is shaped to be able to oppose turning of the screw.

17. An aircraft wheel according to claim 16, wherein the fastener tabs of the rim include respective axial grooves forming abutments against turning of the head of a screw.

18. Landing gear including a leg having an end provided with a wheel according to claim 14, and a gear motor having an outlet shaft provided with a pinion arranged to mesh with the sprocket.
